(19) United States
(12) Patent Application Publication
(10) Pub. No.: US 2023/0331555 A1
(43) Pub. Date: Oct. 19, 2023

(54) Methods for Preparation of Electroactive Lithium Mixed Metal Materials for High Energy Density Batteries

(71) Applicant: Lithium Werks Technology BV, AM Enschede (NL)

(72) Inventor: Yazid Saidi, Cedar Park, TX (US)

(73) Assignee: Lithium Werks Technology BV, AM Enschede (NL)

(21) Appl. No.: 18/135,933

(22) Filed: Apr. 18, 2023

Related U.S. Application Data
(60) Provisional application No. 63/332,656, filed on Apr. 19, 2022.

(51) Int. Cl. C01B 25/30; C01B 25/26; C01B 25/37

(52) U.S. Cl. CPC C01B 25/30; C01B 25/265; C01B 25/372

(57) ABSTRACT

Methods of making a lithium mixed metal compound by reaction of starting materials are provided. The methods can include reacting and/or processed reacted starting materials to form the lithium mixed metal compound in the presence of a fluorine rich atmosphere or media.

### CROSS REFERENCE TO RELATED APPLICATION

This application claims priority to and the benefit of U.S. Provisional Patent Application Ser. No. 63/332,656 filed Apr. 19, 2022, entitled “Methods for Preparation of Electroactive Lithium Mixed Metal Materials for High Energy Density Batteries”, the entirety of which is incorporated by reference herein.

### TECHNICAL FIELD

The present disclosure relates to the preparation of lithium mixed metal materials, and in particular embodiments, the preparation of electroactive lithium mixed metal materials for high energy density batteries.

### BACKGROUND

Lithium-ion battery technology has enjoyed a lot of attention in recent years and provides the preferred portable battery for most electronic devices in use today; however, lithium is not a cheap metal to source and is considered too expensive for use in large scale applications.

The present disclosure provides processes for preparing lithium mixed metal compounds that avoid the production of impurities thereby providing a cost-effective electrode that contains an active material that is capable of achieving a considerably higher specific charge capacity than would be expected from conventional theoretical calculations. Further, it is desirable for such active materials to be straightforward to manufacture and easy to handle and store. Further still, the present invention aims to provide an electrode which is able to be recharged multiple times without significant loss in charge capacity. In particular the present invention will provide an energy storage device that utilizes an electrode of the present invention for use in a sodium-ion cell or a sodium metal cell.

The electrodes according to the present disclosure are suitable for use in many different applications, for example energy storage devices, rechargeable batteries, electrochemical devices and electrochromic devices.

Advantageously, the electrodes according to the present disclosure are used in conjunction with a counter electrode and one or more electrolyte materials. The electrolyte materials may be any conventional or known materials and may comprise either aqueous electrolyte(s) or non-aqueous electrolyte(s).

The present disclosure also provides an energy storage device that utilizes an electrode comprising the active materials.

### SUMMARY

Methods of making a lithium mixed metal compound by reaction of starting materials are provided. The methods can include reacting and/or processed reacted starting materials to form the lithium mixed metal compound in the presence of a fluorine rich atmosphere or media.

### DRAWINGS

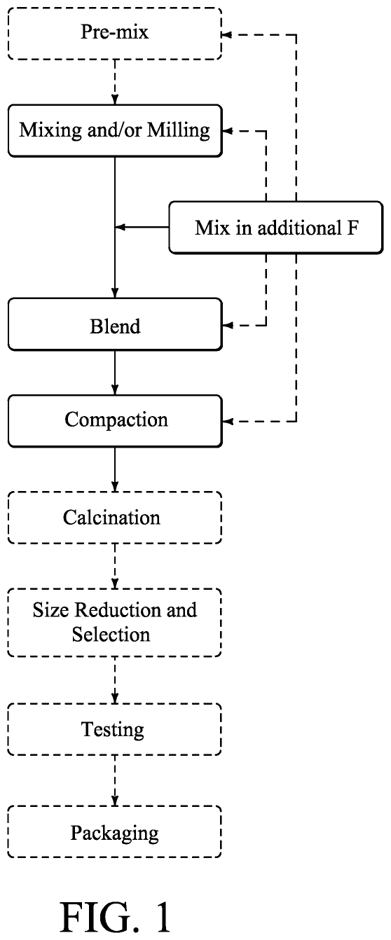

Embodiments of the disclosure are described below with reference to the drawing, FIG. 1, which depicts a process and/or method according to an embodiment of the disclosure.

### DESCRIPTION

This disclosure is submitted in furtherance of the constitutional purposes of the U.S. Patent Laws “to promote the progress of science and useful arts” (Article 1, Section 8).

The present disclosure will be described with reference to FIG. 1 which represents a general process of the preparation of the electroactive lithium mixed metal materials. Portions of this general process are detailed herein as well as in related U.S. Pat. No. 6,387,568 issued May 14, 2002, entitled “Lithium Metal Fluorophosphate Materials and Preparation Thereof”; U.S. Pat. No. 6,528,033 issued Mar. 4, 2003, entitled “Method of Making Lithium-Containing Materials”; U.S. Pat. No. 7,338,647 issued Mar. 4, 2008, entitled “Synthesis of Cathode Active Materials”; U.S. Pat. No. 8,163,430 issued Apr. 24, 2012, entitled “Synthesis of Metal Compounds Under Carbothermal Conditions; and/or U.S. Pat. No. 8,313,719 issued Nov. 20, 2012, entitled “Method of Making Active Materials for Use in Secondary Electrochemical cells”, the entirety of which are incorporated by reference herein, each of which is to read in the context of the drawing of the present disclosure.

The preparation of the materials and/or methods of the present disclosure can be performed in multiple steps or a single step. When performed in multiple steps, the first step can include mixing the raw materials and firing the raw materials to produce the “VPO₄” and/or V-P-O-C precursor. This is shown by the following carbothermal reduction reaction.
0.5 V₂O₅+(NH₄)₂HPO₄+C⇒VPO₄+2 NH₃+1.5 H₂O+CO

An approximate 10-20% mass excess of carbon is used in this reaction to provide a composite incorporating carbon. A larger carbon excess may be used (up to 100%) with a range between 20% and 100%. An example mix can include:
V₂O₅=90.9 g
(NH₄)₂HPO₄=132.1 g
Carbon=14.4 g (20% excess)

In accordance with an example implementation, the raw materials can be weighed out and 1 kg of the raw material mix was placed in a container with 5 kg of ball roller media and placed on a roller mill for a period of 48 h. Ball milling may be used to replicate or improve the mixing/milling process which is achieved in the lab scale process. After milling, the mixture is passed through a coarse sieve to separate the powder from the media, and the powder is then compacted into a crucible prior to firing. The crucibles may be placed in a tube/rotary (being used as a tube) furnace and fired at 650° C. at a ramp rate of 2° C./min with an 8 h dwell under an inert atmosphere. After firing, the pellet is broken up and ground to produce a powder. It should be noted that the VPO₄ is in fact an amorphous V-P-O-C precursor.

In accordance with another example implementation, the first step can include:

0.5 V₂O₅+H₃PO₄ are mixed in water at about 70° C., which can form a relatively clear blue solution to which carbon (20% excess) is added. The solution is then dried in air and then fired at 650° C. in inert atmosphere.
V₂O₅=90.9 g
100% H₃PO₄=98.0 g (modify for lower conc. phosphoric acid)
Carbon=14.4 g (20% excess)

In accordance with another embodiment of the first step PEG (polyethylene glycol) can be added. Accordingly:
V₂O₅=90.9 g
100% H₃PO₄=98.0 g (can be modified for lower conc. phosphoric acid)
Carbon=6.00 g−less carbon due to PEG
PEG=18.1 g
H₂O

The process can include mixing by roller milling components overnight (adding more water if necessary), then water is evaporated to form a cake, breaking up cake and roller milling to form product of step one.

In accordance with another first step example:

0.5 V₂O₅+H₃PO₄+C (as sucrose, for example) can be mixed in water at 70° C. Stoichiometric amounts of V₂O₅ and phosphoric acid can be used with sucrose added in excess (sucrose can form reducing carbon during the thermal decomposition stage). This can form a clear, blue solution which can be heated in air until dryness at for example 650° C. to form the V-P-O-C precursor.

In a second step or as part of a single step, the obtained precursor from Step 1 can be mixed with LiF and then fired to produce the final product LiVPO₄F. This is shown by the following reaction. The reactants can be provided in stoichiometric amounts (ignoring at this stage the residual carbon in the VPO₄ from Step #1)

VPO_{4 +}LiF⇒LiVPO₄F

Accordingly reagents can be provided as follows:
VPO₄=145.9 g
LiF=25.9 g

The “VPO₄” and/or V-P-O-C precursor obtained and LiF can be placed in a container with media (again a 1 kg material:5 kg media ratio) and placed on a roller mill for a period of 24 h. After milling, the mixture is passed through a coarse sieve to separate the powder from the media, and the powder can then be pelletized prior to firing. Under an inert atmosphere, the pellets can be packed in carbon and placed in a sealed container. This container can then be transferred and placed in a box oven at 700° C. and fired for 45 min under Nitrogen. After firing, the pellets can be broken up, ground, sieved and classified to produce the final LiVPO₄F material.

In accordance with another implementation, upon formation of the relatively clear blue solution described above, rather than drying, LiF can be added to the blue solution, then solution dried to a cake, compressed, then fired at 700° C. per the above.

It has been discovered that when using the two-step heat treatments, during the second step heat treatment, the impurities Li₃V₂(PO₄)3, V₂O₃, and/or LiVOPO₄ are formed as part of the heat treatment with rapid calcination and/or the rapid cooling.

In order to limit the formation of these impurities, the present disclosure provides for an F-rich atmosphere as part of steps and/or throughout the reaction process. This enhances the phase stability of LiVPO₄F over the thermodynamic formation of the impurity phases. As can be seen in FIG. 1, additional F can be provided between “mixing and/or milling” and blending, as part of the pre-mix, as part of the “mixing and/or milling”, as part of the blending, and/or as part of the compaction.

Carbothermal reduction can be applied either by using carbon or an organic compound and can be performed in a single step without a dried VPO4 precursor and the F source can be a fluoropolymer.

Example fluoropolymers can include, but are not limited to: PVF (polyvinylfluoride), PVDF (polyvinylidene fluoride), PTFE (polytetrafluoroethylene), PCTFE (polychlorotrifluoroethylene), PFA, MFA (perfluoroalkoxy polymer), FEP (fluorinated ethylene-propylene), ETFE (polyethylenetetrafluoroethylene), ECTFE (polyethylenechlorotrifluoroethylene), FFPM/FFKM (Perfluorinated Elastomer [Perfluoroelastomer]), FPM/FKM (Fluoroelastomer [Vinylidene Fluoride based copolymers]), FEPM (Fluoroelastomer [Tetrafluoroethylene-Propylene]), PFPE (Perfluoropolyether), PFSA (Perfluorosulfonic acid), and/or Perfluoropolyoxetane.

As one example, the F source can be provided as the V-P-O-C precursor is reacted with LiF and maintained as a source about the reaction until storage of the lithium mixed metal. In accordance with other implementations, without drying the V-P-O-C precursor, the F source can be provided with the LiF when added to the relatively clear blue solution described above and then processed accordingly. In the context of the drawing, the additional F can be provided during and/or after mixing and/or milling, but maintained during blending and/or compaction.

Accordingly, methods of making a lithium mixed metal compound by reaction of starting materials are provided. The methods can include reacting starting materials to form the lithium mixed metal compound in the presence of a fluorine rich atmosphere. In accordance with example implementations, the starting materials comprise vanadium phosphate and a lithium halide; vanadium oxide, phosphate, and a carbon source. The starting materials can be mixed in particle form.

The starting materials can include a lithium compound selected from the group of lithium carbonate, lithium phosphate, lithium oxide, lithium vanadate, and mixtures thereof. Accordingly, the starting materials can include a metal compound having a metal selected from the group consisting of Fe, Co, Ni, Mn, Cu, V, Sn, Ti, Cr, and mixtures thereof.

The mixed metal compound may be selected from the group including Fe₂O₃, V₂O₅, FePO₄, VO₂, Fe₃O₄, LiVO₃, NH₄VO₃, and mixtures thereof. The metal compound is a metal oxide or a metal phosphate.

The starting materials can be heated at a temperature sufficient to form a single-phase reaction product comprising lithium, a reduced metal ion, and a phosphate group. Accordingly, the starting materials can include a metal compound and a lithium compound selected from the group consisting of lithium acetate (LiOOCCH3), lithium nitrate (LiNO3), lithium oxalate (Li₂C₂O₄), lithium oxide (Li₂O), lithium phosphate (Li₃PO₄), lithium dihydrogen phosphate (LiH₂PO₄), lithium vanadate (LiVO₃), and lithium carbonate (Li₂CO₂), and carbon present in an amount sufficient to reduce the oxidation state of at least one metal ion of said starting materials without full reduction to an elemental state; and heating said starting materials at a temperature sufficient to form a single-phase reaction product.

The phosphate compound of the process can be selected from the group consisting of diammonium hydrogen phosphate, ammonium dihydrogen phosphate, and mixtures thereof to form a metal oxide or a metal phosphate.

The heating described herein can be conducted at a ramp rate of up to about 10° C./minute to an elevated temperature of between about 400° C. and about 1200° C., and then maintaining said elevated temperature until said reaction product is formed, and this elevated temperature can be maintained between several minutes to several hours.

The carbon source can be present in an amount sufficient to reduce the oxidation state of at least one metal ion of the starting materials without full reduction to an elemental state. The carbon source can be considered a source of reducing carbon. The source of reducing carbon may be supplied by elemental carbon, by an organic material, and/or by mixtures thereof. The organic material is one that can form decomposition products containing carbon in a form capable of acting as a reductant.

The starting materials can be heated to a temperature sufficient to form a reaction product comprising lithium and the reduced metal ion in a non-oxidizing atmosphere. Example non-oxidizing atmospheres can include a gas selected from the group consisting of argon; nitrogen; a mixture of carbon monoxide and carbon dioxide generated by said heating of said carbon in said starting materials; and mixtures thereof within a vacuum for example.

The reacting can include heating said starting materials at a temperature sufficient to form a single-phase reaction product comprising lithium, a reduced metal ion, and a phosphate group with the starting materials comprise a metal compound and a lithium compound selected from the group consisting of lithium acetate (LiOOCCH₃), lithium nitrate (LiNO₃), lithium oxalate (Li₂C₂O₄), lithium oxide (Li₂O), lithium phosphate (Li₃PO₄), lithium dihydrogen phosphate (LiH₂PO₄), lithium vanadate (LiVO₃), and lithium carbonate (Li₂CO₂), and carbon present in an amount sufficient to reduce the oxidation state of at least one metal ion of said starting materials without full reduction to an elemental state; and heating said starting materials at a temperature sufficient to form a single-phase reaction product.

The lithium mixed metal compound formed can include Li_{z}M_{1-y}M′_{y}PO₄X where 0≤y≥1, 0≤z≥1, where M is selected form the group consisting of Mn, V, Cr, Ti, Fe, Co, Ni, Nb, Mo, and mixtures thereof, and where M′ is selected from the group consisting of Mn, V, Cr, Ti, Fe, Co, Ni, Nb, Mo, Al, B, and mixtures thereof, and X is a halogen. In specific embodiments, the mixed metal compound has the nominal formula LiMnPO₄F.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1. A method of making a lithium mixed metal compound by reaction of starting materials, the method comprising reacting starting materials to form the lithium mixed metal compound, the reacting occurring in the presence of a fluorine rich atmosphere.

2. The method of claim 1 wherein the starting materials comprise vanadium phosphate and a lithium halide.

3. The method of claim 1 wherein the starting materials comprise vanadium oxide, phosphate, and a carbon source.

4. The method of claim 3 wherein the starting materials are mixed in particle form.

5. The method of claim 3 wherein the carbon source is present in an amount sufficient to reduce the oxidation state of at least one metal ion of the starting materials without full reduction to an elemental state.

6. The method of claim 5 wherein the carbon source comprises elemental carbon.

7. The method of claim 5 wherein the carbon source comprises an organic material.

8. The method of claim 2 further comprising heating the starting materials at a temperature sufficient to form a reaction product comprising lithium and said reduced metal ion.

9. The method of claim 6 wherein said heating is conducted in a non-oxidizing atmosphere.

10. The method of claim 7 wherein said non-oxidizing atmosphere comprises gas selected from the group consisting of argon; nitrogen; a mixture of carbon monoxide and carbon dioxide generated by said heating of said carbon in said starting materials; and mixtures thereof.

11. The method of claim 7 wherein said non-oxidizing atmosphere is a vacuum.

12. The method of claim 1 wherein the starting materials comprise a lithium compound selected from the group consisting of lithium carbonate, lithium phosphate, lithium oxide, lithium vanadate, and mixtures thereof.

13. The method of claim 1 wherein the starting materials include a metal compound having a metal selected from the group consisting of Fe, Co, Ni, Mn, Cu, V, Sn, Ti, Cr, and mixtures thereof.

14. The method of claim 11 wherein said metal compound is selected from the group consisting of Fe₂O₃, V₂O₅, FePO₄, V₀₂, Fe₃O₄, LiVO₃, NH₄VO₃, and mixtures thereof.

15. The method of claim 11 wherein said metal compound is a metal oxide or a metal phosphate.

16. The method of claim 11 wherein said metal compound is V₂O₅.

17. The method of claim 1 wherein the reacting comprises heating said starting materials at a temperature sufficient to form a single-phase reaction product comprising lithium, a reduced metal ion, and a phosphate group.

18. The method of claim 1 wherein the starting materials comprise a metal compound and a lithium compound selected from the group consisting of lithium acetate (LiOOCCH₃), lithium nitrate (LiNO₃), lithium oxalate (Li₂C₂O₄), lithium oxide (Li₂O), lithium phosphate (Li₃PO₄), lithium dihydrogen phosphate (LiH₂PO₄), lithium vanadate (LiVO₃), and lithium carbonate (Li₂CO₂), and carbon present in an amount sufficient to reduce the oxidation state of at least one metal ion of said starting materials without full reduction to an elemental state; and heating said starting materials at a temperature sufficient to form a single-phase reaction product.

19. The method of claim 16 wherein said starting materials include a second metal compound having a second metal ion which is not reduced and which forms a part of said reaction product.

20. The method of claim 16 wherein said starting materials include a phosphate compound selected from the group consisting of diammonium hydrogen phosphate, ammonium dihydrogen phosphate, and mixtures thereof.

21. The method of claim 16 wherein said metal compound is a metal oxide or a metal phosphate.

22. The method of claim 16 wherein said metal compound is V₂O₅.

23. The method of claim 16 wherein said heating is conducted at a ramp rate of up to about 10° C./minute to an elevated temperature of between about 400° C. and about 1200° C., and then maintaining said elevated temperature until said reaction product is formed.

24. The method of claim 23 wherein said elevated temperature is maintained for between several minutes to several hours.

25. The method of claim 1 wherein the reacting is a second stage of a two-stage process.

26. The method of claim 1 wherein the lithium mixed metal compound comprises Li_{z}M_{1-y}M′_{y}PO₄X where 0≤y≥1, 0≤z≥1, where M is selected from the group consisting of Mn, V, Cr, Ti, Fe, Co, Ni, Nb, Mo, and mixtures thereof, and where M′ is selected from the group consisting of Mn, V, Cr, Ti, Fe, Co, Ni, Nb, Mo, Al, B, and mixtures thereof, and X is a halogen.

27. The method of claim 1 wherein said active material has the nominal formula LiVPO₄F.
